(19) United States
(12) Patent Application Publication
(10) Pub. No.: US 2012/0278241 A1
(43) Pub. Date: Nov. 1, 2012

(54) TRACEABLE AND NON-REPUTABLE TRANSACTION DEVICES AND METHODS

(76) Inventors: Kerry D. Brown, Portola Valley, CA (US); Peter Landrock, Cambridge (GB); Ronald P. Knapp, Los Altos, CA (US)

(21) Appl. No.: 13/549,454

(22) Filed: Jul. 14, 2012

Related U.S. Application Data
(63) Continuation-in-part of application No. 12/647,713, filed on Dec. 28, 2009.
Application No. 12/647,713 is a continuation-in-part of application No. 12/983,186, filed on Dec. 31, 2010, now Pat. No. 8,224,293.

(51) Int. Cl. G06Q 40/00; H04L 9/32

(52) U.S. Cl. 705/67; 705/44

(57) ABSTRACT

Data and financial transactions are secured on a mobile electronics device for traceability and non-repudiation. A mobile personal trusted device (PTD) is needed to communicate over a network to a transaction server. Characteristic abstracts of objects carried by users have distinctive features that can be associated with and registered to a particular user and are recorded. An abstract contemporaneously obtained during a secure transaction is sent to a server for use as an authenticator for comparison to an abstract previously obtained and registered to said user. A traceable transaction record is rendered that is highly identifiable and substantially indisputable.

### RELATED APPLICATIONS

This application is a continuation-in-part of U.S. patent application Ser. No. 12/647,713, filed Dec. 28, 2009, titled VIRTUALIZATION OF AUTHENTICATION TOKEN FOR SECURE APPLICATIONS (Docket MLF 715-01); and also, a continuation-in-part of U.S. patent application Ser. No. 12/983,186, filed Dec. 31, 2010, titled ENCODED COLORGRAM FOR MOBILE DEVICE SECURITY, which will issue as U.S. Pat. No. 8,224,293, on Jul. 17, 2012 (Docket MLF 715-03).

### BACKGROUND OF THE INVENTION

1. Field of the Invention

The present invention relates to electronic transaction systems, and more particularly to devices and methods that make transactions traceable to the parties involved and non-reputable.

2. Description of Related Art

Advances in electronic device technology, wireless communications, and networking are putting more and more capabilities in the hands of consumers and businesses alike. Credit cards began as simple card blanks of plastic with a user's account number embossed on them, and developed into smartcards with impressive wireless technology and cryptographic processing onboard for user authentication. There seems to be less reason to maintain the credit card format, especially in transactions where the user simply waves the card over a contactless reader in a card-present point-of-sale transaction, or merely reads off the account information in a card-not-present online transaction.

Cellphones, too, have advanced far beyond their initial mission as a telephone, and non-phone mobile devices, such as the iTouch, Amazon Kindle readers, and messaging devices are rapidly being adopted. Smartphones can now connect seamlessly through WiFi networks, provide GPS navigation, and offer an Internet browser. Modern cellphones now almost universally include cameras that are producing increasingly better pictures and make videos complete with sound. One Apple iPhone application even allows the built-in camera to image a UPC barcode on products on store's shelves, and to lookup prices for that same product at nearby competing stores, all in real-time via internal database or external database.

Security and fraud protection have always been difficult challenges in the financial industry. Even small gaps in credit card security have resulted in very large financial losses to the issuing banks, merchants, and cardholders, corporate data centers, and personal data collections. RIM Blackberry devices are lost at a rate of nearly three hundred devices per day, and many have corporate data and personal data on them.

Unfortunately, the electronics and communications protocols used by mobile phones are not capable of supporting secure financial transactions to the association, bank, corporation or user risk profiles, protocols, or standards. Even though a cellphone seems to be an obvious place to park credit card type applications, e.g., using near field communications (NFC) and mobile electronic wallets, many require unique proprietary hardware on the device, and POS levels.

The problem has been that mobile handsets advanced enough to support secure financial transactions had to be custom built. Conventional cell phones could not be employed. Simple 4-digit PIN protection in common mobile phones is typically acceptable for micropayment transactions under about $200 through the phone service provider, or others, but the 40-bit and higher security levels required by credit card issuing banks, and 10-40 bit levels for corporate security and personal security applications was not possible without hardware modification.

Authentication factors are pieces of information that can be used to authenticate or verify the identity of a cardholder. Two-factor authentication employs two different authentication factors to increase the level of security beyond what is possible with only one of the constituents. For example, one kind of authentication factor can be what-you-have, such as magnetic stripe credit card or the SIM card typical to many mobile devices and PTD. The second authentication factor can be what-you-know, such as the PIN code that you enter at an ATM machine. Using more than one authentication factor is sometimes called “strong authentication” or “multi-factor authentication,” and generally requires the inclusion of at least one of a who-you-are or what-you-have, what-you-know authentication factor.

Another recently developing concern is the Man-in-the-Browser (MitB) security attack. It is a trojan that infects a web browser and has the ability to modify pages, modify transaction content or insert additional transactions, all in a completely covert fashion invisible to both the user and host application. MitB attacks succeed in spite of security mechanisms such as SSL/PKI and/or two or three factor authentication solutions are presently in use. Transaction verification has been shown to be an effective way to counter an MitB attack.

Cryptomathic (Denmark) secures Internet and telephone connections with two-factor strong authentication technology. It depends on an “Authenticator” supporting a wide range of tokens and operating on a network as an authentication server. MasterCard Worldwide selected Cryptomathic to manage the data preparation requirements for its deployment of the MasterCard MOBILE OVER THE AIR PROVISIONING SERVICE to enable MasterCard PayPass application to be provisioned on to mobile phones. PayPass lets users make small-item purchases with their mobile phones. Once a bank has signed up to offer the service, its customers can register MasterCard. The PayPass application is sent over-the-air directly onto the customers' mobile phone handsets. The MOBILE OVER THE AIR PROVISIONING SERVICE is operated and managed by MasterCard, and the data preparation system handled by Cryptomathic's Cardlnk. Cardlnk generates personalization data for the MasterCard PayPass mobile phone applications provisioned through the service in a secure environment for data generation and cryptographic key management during the application issuing process.

MasterCard PayPass is an EMV compatible, “contactless” payment feature based on the ISO/IEC 14443 standard that provides cardholders with a simple way to pay by “tapping” a payment card or other payment device, such as a phone or key fob, on a point-of-sale terminal reader rather than swiping or inserting a card. The EMV standard defines the physical, electrical, data and application levels between the cards and card processing devices for financial transactions. Portions of the standard are heavily based on the IC Chip card interface defined in ISO/IEC 7816. MasterCard credit cards continue to have the option of four lines of embossing. That extra space is usually used to accommodate a contactless credit card's antenna. So an optimized chip coupled with a smaller antenna was needed. Texas Instruments (Dallas, Tex.) markets vertically integrated antennas in the product design for improved performance and flexibility. The PayPass inlay solution incorporates a secure, low-power microprocessor with an embedded PayPass application and a small-size radio frequency antenna into a thin, PVC pre-laminate sheet, or “pre-lam,” that can is easily integrated into standard card manufacturing production processes. The secure microprocessor was designed to meet the needs of the contactless payment infrastructure for the North American market. The inlay is small enough to enable four-line embossing, supports the four centimeter read range requirements of PayPass.

In general, a drag and drop security layer mechanism is needed that can be associated with financial, corporate data, personal (photos and other folders), and other native and user-installed applications. Mobile phones in particular need strong authentication resources if they are to be used in financial transactions. The ideal implementations would not require access to a server and not depend on hardware modifications or additions, and users would be relieved of having to remember long, incomprehensible PIN codes, or operations worthy of a computer programmer.

The average user cannot commit to memory complex enough passwords that would allow derivation of a cryptographic key to use to secure transactions and authentication users, which would typically have a 128-bit minimum entropy requirement. Such users are also overly challenged when required to have a different password for every secure website they visit. Most users simply repeat the use of a few favorite passwords and then don't change them often enough. Such passwords are thus easily compromised via brute force or by carrying over an attack on one website to another.

Authentication factors are pieces of information that can be used to authenticate or verify the identity of an individual. Two-factor authentication employs two different authentication factors to increase the level of security beyond what is possible with only one of the constituents. For example, one kind of authentication factor includes what-you-have, e.g., an electromagnetic stripe credit card, the SIM card typical to many mobile devices and Personal Trusted Devices (PTDs), or other object that is unique and difficult to duplicate. Another type of authentication factor includes what-you-know, such as a user password, a PIN like those used for accessing ATM machines at banks, or other pieces of secret information. A third kind of authentication factor includes who-you-are, for example a personal signature, a voice sample, a fingerprint, an iris scan, or other type of biometric.

Using more than one authentication factor results in what is sometimes called “strong authentication” or “multi-factor authentication.” A very common use of strong authentication generally includes just two different factors, the what-you-know and what-you-have authentication factors.

Barcodes and conventional one-dimensional (1D) and two-dimensional (2D) codes do not have the data storage capacity needed to make an effective what-you-have security factor out of them. They typically have been used for serial numbers and stock keeping unit identifiers. Such traditional devices are so limited that they cannot be expected to carry much information. This is usually due to standardized shape geometries that can't be easily scaled, rotated, or changed in shape.

When smartphones and other personal mobile electronic devices are used for secure access and to make consumer financial transactions, the loss of the device can be devastating and costly. What is needed are methods and even a personal mobile security appliance that can prevent unauthorized use even when the appliance itself has fallen into the wrong hands.

### SUMMARY OF THE INVENTION

Briefly, a computer executable file embodiment of the present invention for securing financial transactions with a mobile electronics device comprises three downloadable modules. A first module provides for the mobile electronics device and a network server to interactively register a sound or an image of an object usually carried by the user. These sounds and objects represent physical passwords from which processing can derive an adequate number of bits of characterizing information to meet the risk profiles of the data and application-specific entity. A second module is activated during a user authentication for financial transaction and uses a camera and/or microphone input of the mobile electronics device to collect a new sample of the physical password. A cryptographic abstract of it is distilled and compared to preregistered cryptographic abstracts or their mathematical keys, either locally or by accessing a remote server on the Internet, depending on the dollar amounts involved or the level of security required by the application-specific issuer or entity. A third module provides a key recovery process, such as is needed when the physical password sound or object is no longer available to the user. The user synchronizes the mobile electronics device on a entity website, virtual private network (VPN), or other data network and requests key removal. Or the user contacts the vendor to obtain a reset code. New physical passwords can then be registered with the first module after the temporary passphrase is obtained.

In another aspect, a security embodiment of the present invention includes a software application operating in a user's smartphone or PTD and a separately carried visual key that the user can image at will with the smartphone's camera. An effective visual key would typically comprise digital data encoded in a series of colored cells arranged in a colorgram. Such digital data is treated as a what-you-have security factor, and is concatenated with other security factors so users can authenticate themselves to websites, internet services, and even the smartphone device itself, or its applications. In one aspect, when users authenticate themselves to a server, the server returns a short-term supply of one-time-passwords or account numbers for use in secure access and financial transactions on other systems. A remapping key can be changed to allow subsequent usage of a specific colorgram. This can be very useful in hybrid-key methods similar to PKI, where data is encoded to a publicly available colorgram.

A security gateway is also provided for internet applications and social networking when accessed by consumer mobile devices. An email client, private photos, private documents, and other personal and confidential files can be secured in files in a virtual vault on the user's mobile device using cryptographic keys. Users are provided with representative links to their favorite websites in the virtual vault, and pressing or clicking on an icon will launch an auto-capture sequence, extract a cryptographic key from a provided colorgram, and direct the smartphone's web browser to a bookmarked page. The respective login data can be auto-filled for the website. A watchdog timer may be included to close the virtual vault when it has been idle more than a predetermined time.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of a mobile device embodiment of the present invention for use in high security multi-factor applications;

FIG. 2 is a flowchart diagram of a financial payment system embodiment of the present invention that enables a mobile device to be used in financial transactions or other high security multi-factor applications;

FIG. 3 is a flowchart diagram of a collect-and-process object image program embodiment of the present invention;

FIGS. 4A and 4B are opposite side views of a typical house key showing some of the representative features that can be selected and reduced into encrypted abstracts suitable for registration and transaction authentication;

FIG. 5 is a functional block diagram of a highly specialized application of an encrypted colorgram system embodiment of the present invention;

FIG. 6 is a diagram of a colorgram embodiment of the present invention;

FIG. 7 is a diagram of a key fob embodiment of the present invention with a colorgram;

FIG. 8 is a diagram of a key ring embodiment of the present invention with several keys each having its own colorgram;

FIG. 9 is a flowchart diagram of a computer subroutine to read and interpret colorgrams and to extract their digital encodings;

FIG. 10 is a flowchart diagram of a colorgram recognition process embodiment of the present invention; and

FIG. 11 is a flowchart diagram of a top level program to run on a smartphone with colorgrams to authenticate users to application programs.

### DETAILED DESCRIPTION OF THE INVENTION

In general, embodiments of the present invention provide for strong authentication with conventional mobile devices that include at least a camera and a way to at least occasionally connect with a wireless network. Such mobile devices typically have a unique subscriber information module (SIM) card installed to provide one unique device identifier, or may have other unique identifiers such as UUID/MAC address/UDID/etc., that may be used for a traceable authentication factor. Users will invariably have house keys or other objects they usually carry with them that are personalized and different from those kept by other users. So the camera in a conventional mobile device is used to collect an image of a selected item, and an encrypted abstract of that image is used to verify what-you-have as one of its authentication factors. The higher levels of authentication are achieved by imaging two or more objects, such as a house key and a car key. The number of characterizing points in each object mathematically squares with the others and thus multiplies. Simple 4-digit PIN codes can thus be employed in a what-you-know authentication factor to conjoin with the what-you-have authentication factor for a strong multi-factor authentication, e.g., comprising device identification, user parametrics, and a physical token.

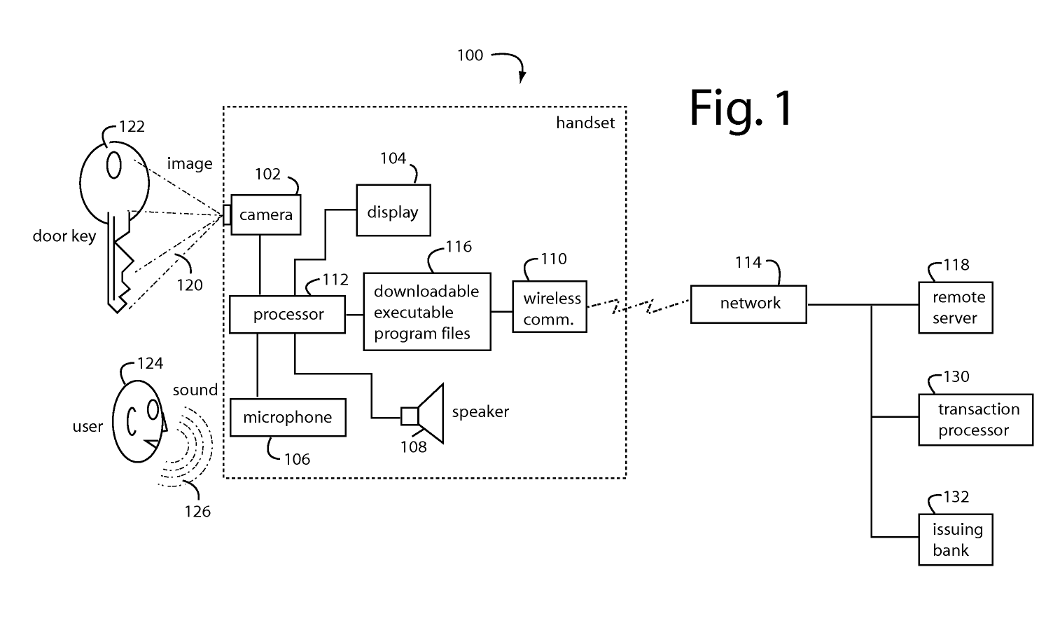

FIG. 1 illustrates a personal trusted device (PTD) or mobile device embodiment of the present invention for use in financial transactions, and is referred to herein by the general reference numeral 100. For example, a handset 100 provides mobile telephone functions on a GSM network. It includes a camera 102, a display 104, a microphone 106, a speaker 108, and a wireless communications interface 110. A processor 112 includes its own program code to operate the handset 100 as a conventional feature cellphone or smartphone with connections through a network 114 like the GSM mobile phone network, WiFi, or the Internet.

If not originally provisioned, a set of downloadable and executable program files 116 can be downloaded from a remote server 118 through network 114, or inserted on a memory card into handset 100. These downloadable and executable program files 116 provide additional functionality to the handset 100. In particular, when executed by processor 112, downloadable and executable program files 116 provide strong authentication for local data security, remote data access, or financial transactions involving the handset 100 as a sort of smartcard payment card.

Camera 102 is used to collect images 120 of the blades of cut keys like car keys, house keys, or other objects 122 that a user typically carries with them. Common keys have blade grooves and a series of teeth or bittings and notches that can be measured on camera to generate matching points like in automated fingerprint recognition and authentication. (Cameras in typical cellphones do not have the resolution necessary to directly image the fine ridges in photos of fingertips.) A typical one-sided house key has six teeth that can each have one of four levels. That would provide twenty-four unique combinations, but two such keys used together provides the square of twenty-four, or five hundred seventy-six combinations. Adding in other visual aspects of the imaged objects, such as blade grooves and key bow logos, would provide similar increases in multiplying combinations.

The use of a mobile electronics device to collect an image of a physical token can not only include a door key or car key, but also identification cards, passports, drivers licenses, pendants, rings, bracelets, belts, handwritten signatures or phrases, hand of said user, or other objects not subject to unavailability or substantial changes in appearance over time.

The use of visual objects is essential a non-biometric what-you-have type of authentication, that is if the object imaged is not the user themselves. In a biometric type authentication using voice recognition, a user 124 could speak or make sounds 126 to identify themselves. Voiceprints obtained through microphone 106 allow the generation of who-you-are authentication factors, that can be combined in ever stronger multi-factor authentication protocols. Voice recognition software included in the downloadable and executable program files 116 provides for speaker identification through sound spectrograms, the actual words spoken would carry no importance so eavesdropping would not benefit a fraudster. The words to speak could even be suggested in real-time, to rule out spoofing with recordings of the user. In which can recognition software would be included to verify that the suggested word or phrase was the one spoken in response. Highly reproducible sounds, such as ring-tones or recordings can also be employed.

Cryptograms processed and stored on servers can be far more complex and thus more secure, since mobile devices can send raw data more quickly than they can process it themselves locally. Thus the mobile device can pass off the chore of processing complex, high security cryptograms to online servers. If stored and processed locally, the cryptograms 210 are opportunistically updated for more strength whenever the mobile device connects to the Internet, or when it opens a wireless application protocol (WAP) connection. Their screen would have the unique SIM Card data, the visual or aural cryptogram, plus the typical 4-digit, or more, parametric PIN code.

It may be that any financial application over a certain dollar amount, e.g., $100, will be required by the financial institutions to make a connection with a server 118, transaction processor 130, or issuing bank 132, and as such will be the primary mode of operation. A traceable transaction record is rendered by transaction processor 130 that is highly identifiable and substantially indisputable. Such may be fetched back as proof when the user tries to deny or repudiate a transaction later.

In alternative embodiments, association and bank authorizations may be cached for virtual cryptogram matching and approval for lesser dollar amounts, e.g., under $50. Corporate security may set protocols for authentication risk profiles to enable access to corporate data via encrypted email, web browser, VPN, or other network.

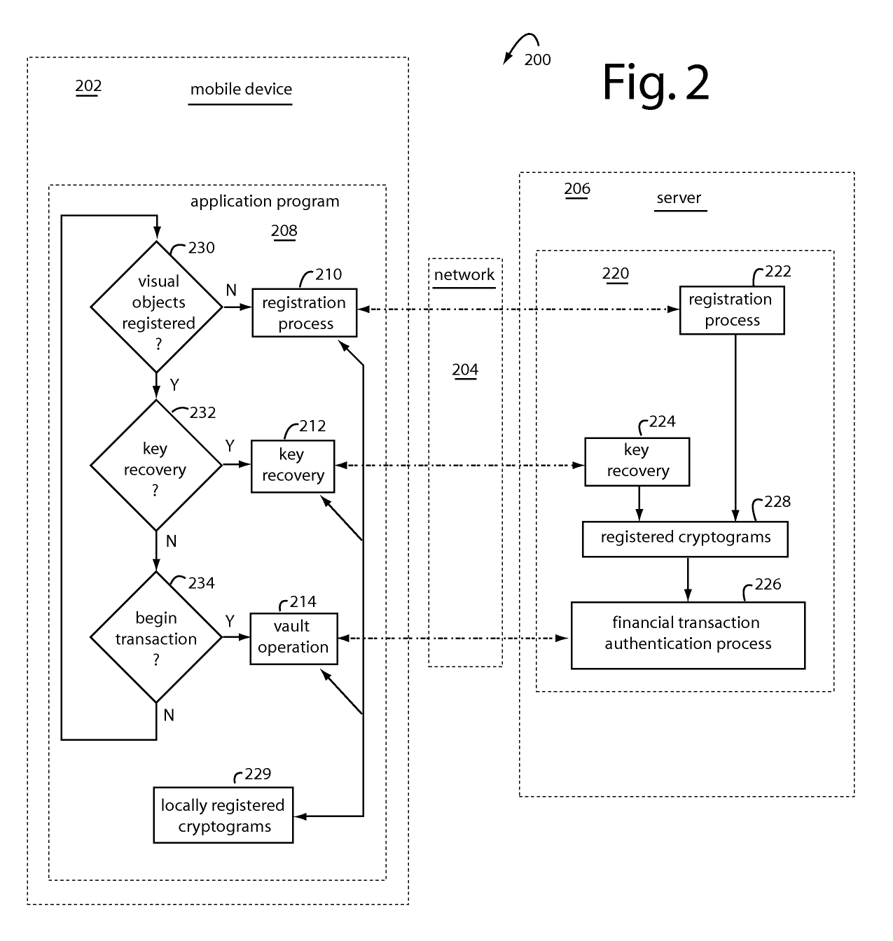

FIG. 2 illustrates financial payment system embodiment of the present invention for a mobile device to enable its use in financial transactions, and is referred to herein by the general reference numeral 200. The financial payment system 200 includes a plurality of mobiles devices 202, such as iPhones, Blackberries, and other smartphones with built-in cameras, and that are able to communicate over a network 204 to a server 206. An application program 208 is downloaded or otherwise installed into the mobile device 202 after purchasing or renting it from a merchant or remote server 206. Application program 208 is like that included in the downloadable and executable program files 116 of FIG. 1, and has three major operation parts that execute on mobile device 202. These are a registration process 210, a key recovery process 212, and a vault operation 214.

Applications could be downloaded to mobile device 202 and used in local mode only, e.g., for nested, or associated, applications on the mobile device. In local only mode, a token or financial data is transmitted to a contactless card reader, such as the VIVOwallet™ proprietary transceiver marketed by VIVOtech, Inc. (Santa Clara, Calif.).

Registration process 210 operates in conjunction with remote server 206. A server program 220 is used to register images 120 (FIG. 1) of objects 122 and/or sounds 126 that will be used during a financial transaction to authenticate user 124. The server program 220 includes three processes that correspond to the three major operation parts that execute on mobile device 202. These are a server visual object registration process 222, a server key recovery process 224, and a financial transaction authentication process 226. Each of these has access to a registered cryptograms database 228 that stores abstracts of the images of the visual objects that have been processed an accepted. These operate as secure passwords or cryptogram keys.

A traceable transaction record is rendered by financial transaction authentication process 226 from tokens, colorgrams, and other security factor information that is highly identified with particular users and is therefore substantially indisputable. Such traceable transaction record may be fetched back from a database or archive later as proof if a user tries to deny, question, or repudiate a transaction.

Since the items stored in registered cryptograms database 228 have been derived from images of objects only the users have, the complexity of the secure passwords or cryptogram keys that can be generated from them by image processing, and feature selection and reduction far exceed any simple conventional password a typical user is likely to be able to remember. The level of discrimination and security thus obtainable by using these as authenticators rises to the levels insisted upon by the world's financial institutions, corporate data, and personal user data files/folders.

Registered cryptograms in database 228 can be topographically mapped and sent through an algorithm, and stored as a data map, or binary sequence, both locally in mobile device 202 and remotely in server 206. Such remote storage can even be on another server somewhere, e.g., operated by a bank, an association, Google, or some cloud computing disintermediated server.

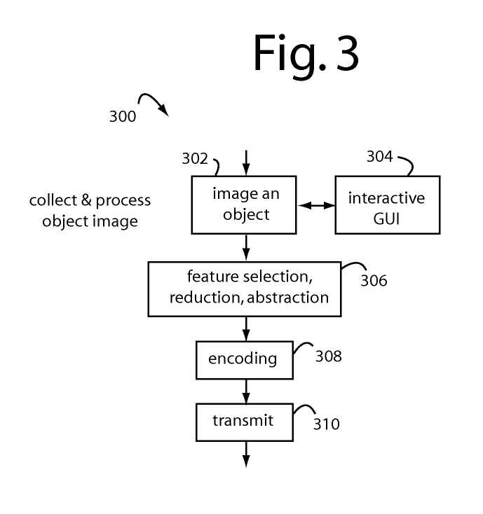

The mobile device registration process 210 and server visual object registration process 222 work together to collect, process, and store abstracts of images of objects the user has and will use as a sort of physical password during transactions with merchants. A decision point 230 asks if any visual objects are registered. If not, or if not all have been registered, the mobile device registration process 210 calls a collect-and-process object image program (FIG. 3) and forwards a candidate encoded abstract through network 204 to the server visual object registration process 222. There, several tests are made as to the adequacy and legitimacy of the candidate encoded abstracts, and the user is verified. Passing these tests, the candidate encoded abstracts are stored in registered cryptograms database 228 in server 206 and/or a local database 229 in mobile device 229. The encoding and encrypting at the server can be much stronger and therefore far more secure because the relatively costly resources of the server can be brought to bear. It therefore can occur that certain transactions may only be authenticated by consulting the server registered cryptogram database 228. The local database 229 and its encryptions can be regarded as less secure and less robust in the face of fraud and other attacks. The image can be processed and returned to the PTD or mobile device 229 for local image comparison in future, or it can be processed locally, albeit a step that requires significant time.

A second decision point 232 asks the user if any lost keys need to be recovered. For example, if the house key that was used originally during registration is no longer available to the user. From the user's point of view, a new object can therefore be used to replace the original one. In actuality, an encoded abstract of the original two-dimensional image of the first object is replaced, both locally and at server 206.

So, if the second decision point 232 is true, the key recovery process 212 tries to clear out any registered cryptograms in database 228, and calls the collect-and-process object image program (FIG. 3) to forward a candidate encoded abstract of an image of an object through wireless network 204 to the server visual object registration process 222. If the server 206 is not available through network 204, a reset code obtained by the user can be input to the mobile key recovery process 212 to clear out any registered cryptograms in local database 229. Otherwise, the mobile device 202 can be synchronized through a vendor's website, or via phone, chat corporate IT administrator of the device (e.g., Corporate RIM Blackberry devices) to ensure user authentication and authorization based upon registration data entered during the initial registration process and the server key recovery process 224 is used to clear out any registered cryptograms in server registered cryptogram database 228. Clearing either of the cryptogram databases 228 and 229 causes the registration processes 210 and 222 to engage the user for substitute objects to be registered.

A third decision point 234 asks the user if they want to begin a transaction with a merchant, or open a nested or associated application such as email, SMS, local corporate or personal folders, etc. If so, vault operation 214 calls the collect-and-process object image program (FIG. 3) to forward a candidate encoded abstract of an image of an object through network 204 to the server financial transaction process 226. The candidate is compared with those in registered cryptogram database 228 for a match. Any match is interpreted as an authentication of the user, and if the user's account is otherwise valid and available, a merchant authorization code is sent to enable the transaction to complete.

If the server 206 is not available through network 204, a limited risk authentication and authorization can be obtained by having vault operation 214 check the local cryptogram database 229. If the proposed transaction is within previously authorized limits, then an authentication of the candidate encoded abstract of an image of an object against those registered in local cryptogram database 229 can result in an authorization of the transaction. Reconciliations are made later in background with the server financial transaction process 226 when the server 206 becomes available.

FIG. 3 represents a collect-and-process object image program embodiment of the present invention, and is referred to herein by the general reference numeral 300. Such collect-and-process object image program 300 is used in each of registration process 210, key recovery process 212, and vault operation 214 of FIG. 2. When called by another program, a step 302 activates a built-in camera and displays and image for the user. A step 304 includes an interactive graphical user interface (GUI) that instructs the user how to manipulate the object to obtain the best image, and that presents “risk-bars” and other tools that provide user feedback on how well the procedure is progressing toward satisfying predetermined risk level profiles. Risk bars and indicators can be programmed signify to the user the degree of risk officially pegged for such common applications as personal folders, corporate data, financial transaction data, etc.

The GUI can request other objects or allow option selections with a touch-sensitive screen, like display 104 in FIG. 1. A step 306 provides for image processing that includes feature selection, feature reduction, and abstraction of the images obtained in step 302. Such image processing removes the irrelevant background behind and surrounding the object, and uses edge, corner, color, texture and other detection methods to locate and analyze the features of the object. An algorithm in a step 308 encodes these abstracts into a standardized format for secure transmission in a step 310.

The visual cryptogram registration process 210 and GUI step 302 allow users to press a “vault” icon on touch sensitive screen 104 (FIG. 1) to begin a registration process. The vault icon could resemble a large floor safe. A risk-level sub-routine in step 304 allows a level of transactional risk to be associated with various application icons that can be dragged and dropped onto the vault icon. Other user-associated applications can be dragged and dropped on such vault icon as well, e.g., email, corporate databases, personal folders, applications, and remote files.

Most credit card and financial payment applications will require the assignment of at least a 40-bit binary level of risk. So the risk-level indicator sub-routine provides a risk-bar or other user feedback to show with colors or tick marks when an acceptable level of security for a visual cryptogram object has been obtained. In other words, the risk-level sub-routine lets users present various objects and combinations of objects for virtualization by the camera into a cryptogram, and to see if the particular objects are providing enough characteristics that can serve as a basis for authentication. When an acceptable object has been presented, then screen feedback through the GUI step 304 says the object has been accepted for registration. Automatic camera shutter release, data processing, and transmission then follow.

During the registration process, steps 306-310 capture the visual images of objects, virtualize the objects' characteristic points with an algorithm into distilled binary sequence strings, forward the strings to a server, and there the server stores these as authenticators for financial transactions that will follow later from this mobile device. Alternatively, it can be processed locally and stored locally.

The visual cryptogram vault operation process 214 in FIG. 2 is initiated when the user presses the vault icon on the display screen. The screen “opens” to indicate it is scanning with the camera for an object that has been previously registered. Training data can be returned from the registered cryptogram databases to help in the scanning and recognition, e.g., to speed up the time it takes to authenticate the user and get an authorization for the transaction with the merchant. In a typical application, there will be only one or two objects in the registered cryptogram databases 228 and 229, and the great likelihood is that the user is holding up a correct object. The recognition and authentication will therefore be quite speedy. Attempts at fraud will cause delays while the cryptogram vault operation process 214 makes sure that the object being offered as a virtual password is in fact not legitimate. Perhaps the user has a thumb obscuring some important feature of the object and needs to be told so.

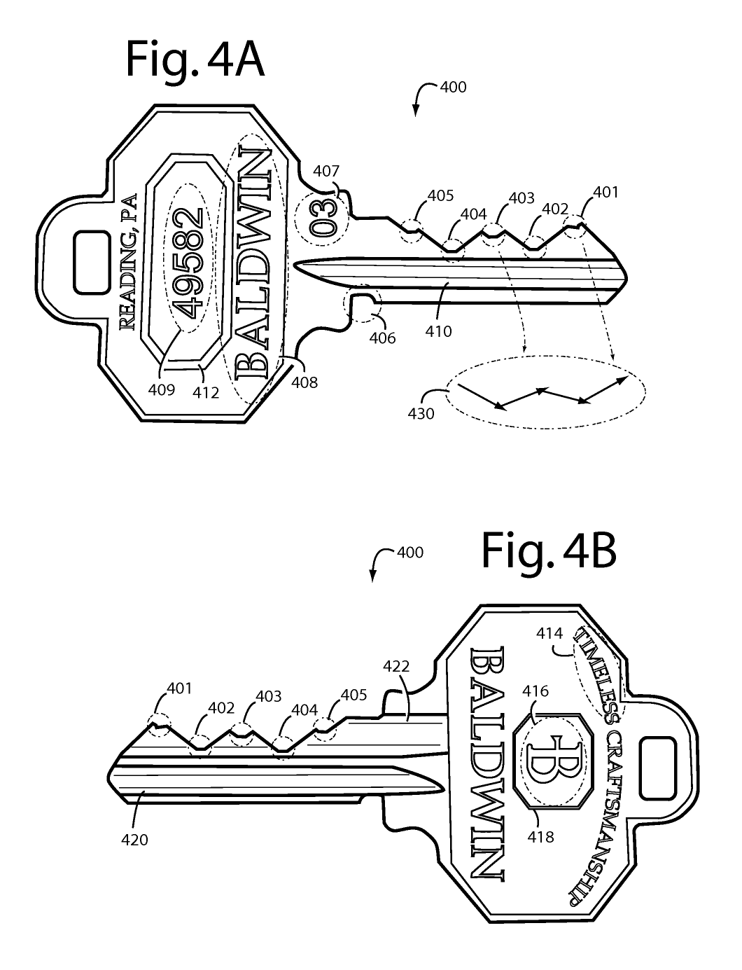

FIGS. 4A and 4B how the abstraction of a virtual cryptogram from a visual object is conducted using camera 102 in handset 100, mobile device 202 or PTD. Virtual cryptograms can also be abstracted from audible objects received by a microphone, e.g., yielding a spectrogram. The best objects for use as virtual cryptograms are those that are likely to be available when the user engages in a financial transaction, and those that are personalized or unique to the particular user. A house key or car key are prime examples.

In FIGS. 4A and 4B, a cut-type door key 400 is illustrated from both sides. A series of cuts 401-405 are arranged on the blade of the key and each represents a tumbler pin position that can be cut to one of four or five levels. This particular key 400 has many edges, textures, colors, and other distinguishing characteristics that can be imaged and included in an abstraction that yields a virtual cryptogram. For example, a notch 406, a stamped number “03” 407, a company logo “BALDWIN” 408, a key number “49582” 409, a keyway 410, a border 412, etc.

On the opposite side shown in FIG. 4B, the series of cuts 401-405 on the blade of the key are in reverse order from FIG. 4A. A slogan “TIMELESS CRAFTSMANSHIP” 414, trademark symbol “B” 416, surrounding border 418, and keyways 420 and 422, are present that distinguish this side of key 400 from the other side.

The features can be selected, isolated, and abstracted by image reduction and processing software to result in a compact binary sequence of more that 40-bits that is easy to forward to a server, store, and retrieve. The combination of elements, their relative orientations, and vectors to one another can be included in the abstractions. For example, a vector chain 430 can be abstracted from the individual vectors between each of the series of cuts 401-405.

If, for some reason, an image of one key 400 does not provide enough characterizing information for an abstraction to satisfy a certain level-of-risk or security, two different such keys can imaged, abstracted, and registered, or the two sides of a single key, like key 400 (FIGS. 4A and 4B) are used in an ad hoc combination. On-screen instructions are presented through a GUI to assist the user in providing the required images and objects. Additionally, a user PIN, typical on many personal trusted devices, can be chained or concatenated with the visual cryptogram by a processing algorithm.

Image processing software is used for background removal and normalization of images, such as variations in angle, zoom, lighting, orientation, wear, etc. Pattern recognition and feature extraction are further employed to abstract particular objects in the images. Feature extraction reduces the resources needed to accurately describe a large set of data by dimensional reduction. A major problem in the analysis of complex data stems from the number of variables involved. Any analysis with a large number of variables generally requires a large amount of memory and computation power, or a classification algorithm which fits over a training sample and generalizes to new samples. Feature extraction includes methods of constructing combinations of the variables to get around these problems while still describing the data with sufficient accuracy.

It is, however, advantageous to select and use objects for registration as visual virtual cryptograms that will express a low entropy, e.g., not wear, age, or change appearance over periods of time. This then implies for practical reasons that the abstractions obtained for registration and the abstractions acquired later during a financial transaction are allowed a small range of fit. It also implies that the abstraction algorithms employed need to be consistent over time how they analyze an image and how they convert what they see into binary strings. Such tasks are not unlike those in more conventional optical character recognition (OCR).

Image feature selection and reduction removes irrelevant and redundant features from the images so the remaining artifacts can be analyzed for their characteristics, distinctive patterns and attributes. This can include edge, corner, blob, ridge, texture, and color detection and scale-invariant feature transform (SIFT) to detect and describe local features in images. Each object in an image has interesting points that can be extracted to provide a “feature” description of the object. The descriptions extracted can be registered in a server as training images and used to identify and authenticate the object. The training images can also help when attempting to locate registered objects in images having a background of many other irrelevant or unauthorized objects. In order for reliable recognition, especially in real-time when trying to authenticate a transaction, the features extracted from the training images should be ones that are relatively insensitive to changes in image scale, noise, illumination and local geometric distortion.

Once registered, the registered images expressed in corresponding abstractions can be used as training images in the mobile device and in the server for accelerating recognition of authentic visual cryptograms.

The issues include the effective identification of features in the images and how to extract them. A difficult task can be in understanding the image domain and obtaining a priori knowledge of what information is required from the image. The best features are those that carry enough information about the image and that do not require any domain-specific knowledge for their extraction. They should be easy to compute, in order for the approach to be feasible for large image collection and rapid retrieval. The images and their features should relate well with human perceptual characteristics since the users will be determining the suitability of the retrieved images.

An advantage of embodiments of the present invention is that the images presented for authentication have a high probability of including a registered object, and any image presented will be one that is supposed to include an authenticating object. The authentication task reduces to matching the obvious objects in the sample images to the registered ones which are few in number, and then to issue an authentication and then authorization.

It may be important as applications develop and fraudsters come up with newer more sophisticated security attacks, for embodiments of the present invention to verify that the image taken for the authentication of a transaction was actually collected at a time and place contemporaneous with the financial transaction. This would prevent archived copies or duplicate objects from being used as surrogates.

The registered objects are preferably things that the user would notice immediately if they went missing, and the key recovery processes would be useful in preventing missing registered objects from being used by mobile devices not previously associated with the user.

Embodiments of the present invention can be implemented as Google ANDROID mobile operating system running on the Linux kernel, and applications that are sold in on-line stores for the Apple iPhone™, RIM Blackberry™, Palm OS, and similar touchscreen smartphone products. No doubt in the near future other, even better ways to host embodiments of the present invention will become available.

Computer executable file embodiments of the present invention provide for the securing of data and financial transactions with a mobile electronics device, and comprises three downloadable modules. A first module provides for the mobile electronics device and a network server to interactively register a sound or an image of an object usually carried by the user and not subject to much change over time. These sounds and objects represent physical passwords from which processing can derive characterizing information, as required by the controlling entity, application, user, or IT administrator for resident applications on the mobile device, or remote applications or data on a server or other mobile device. A second module is activated during a user transaction and uses a camera and/or microphone input of the mobile electronics device to collect a new sample of the physical password and provide user feedback on the level of risk associated with the object. A cryptographic abstract of it is distilled and compared to preregistered cryptographic abstracts, either locally or by accessing a remote server on the Internet, depending on the dollar amounts involved or the level of security required. A third module provides a key recovery process, such as is needed when the preregistered physical password sound or object is no longer available to the user. The user synchronizes the mobile electronics device on a vendor website and requests key removal. Or the user contacts the vendor to obtain a reset code. New physical passwords can then be temporarily registered with the first module.

In general, embodiments of the present invention provide security gateways for applications and social networking accessed by consumer mobile devices. An email client, private photos, private documents, and other personal and confidential files can be encrypted in files on a user's mobile device with cryptographic keys in the encoded visual form of colorgrams. Users' “apps” are displayed as icons in an encrypted vault, and selecting one of them will launch an auto-capture sequence, extract the corresponding key from a captured colorgram, use this to recover a password from the vault, and then launch the appropriate website or file viewer.

Alternatively, the “app” may use a key read from the captured colorgram to generate a One-Time Password (OTP) that will enable the user to log on to a bank account for a higher level of security. The embodiments then auto-fill the respective login data for the website. A watchdog timer may be included to close the encrypted folder vault when it has been idle more than a predetermined time.

Software applications on the phones apply the visual keys after being read by the phone to encrypt a so-called seed, such as a sequence number or a time stamp. And possibly some information from the user such as a password or similar, as is common for OTP schemes, and forwards this calculated OTP for access to a bank account, for example.

A principal advantage of embodiments of the present invention is a secure web server can be used to push new, very long and complex passwords to each of the apps in the encrypted folder vault on a regular basis. Once a user logs on, a back-end server generates one or several new passwords for various apps that may be stored in the secure vaults encrypted under the key encoded in a colorgram. When the user needs an appropriate password for an app, they download the password from a vault, an application on the phone decrypts it and passes it to the appropriate application for log on. One-time passwords may not even be printable with ordinary characters such as letters and numbers, e.g., all ASCII characters. Even user-generated characters, such as smiley faces and icons, may be stored in a secure vault encrypted under a visual key previously supplied to the user.

The users never have to deal with the highly secure passwords directly. The new passwords can be generated with AES cryptography on a Hardware Secure Module (HSM) server, and have superior cryptographic strength to anything users would choose or be able to remember for themselves. All the passwords can be updated regularly, and the user can print them out if needed. Alternatively, new passwords can be transformed into a colorgram by the backend and forwarded to the user possibly encrypted under a key shared between the backend and the app on the device. The user can then print them to be readily available for logon without needing to be on-line connected to the backend. One-time passwords are forwarded to the user as colorgrams that may not require an online connection to the web to be used.

The security of each site is thus strengthened, and users are authenticated to their own encrypted folder vaults in their personal trusted device. Multiple encrypted folder vaults, each accessed with a separate colorgram, can provide for sharing of a single mobile device by multiple users.

In one class of embodiments, credit card and payment card accounts are distilled into “softcards” that are kept in the encrypted folder vault. Unique numbers can be easily generated for each instance of card use. Each new number is generated by a secure server and multiple softcard instances can simultaneously be pushed to the user's mobile device. In one embodiment, the distilled softcard keys are optically transferred to a reprogrammable payment card via the mobile device screen, e.g., by flashing color patterns on the display screen to an optical receiver on the reprogrammable payment card.

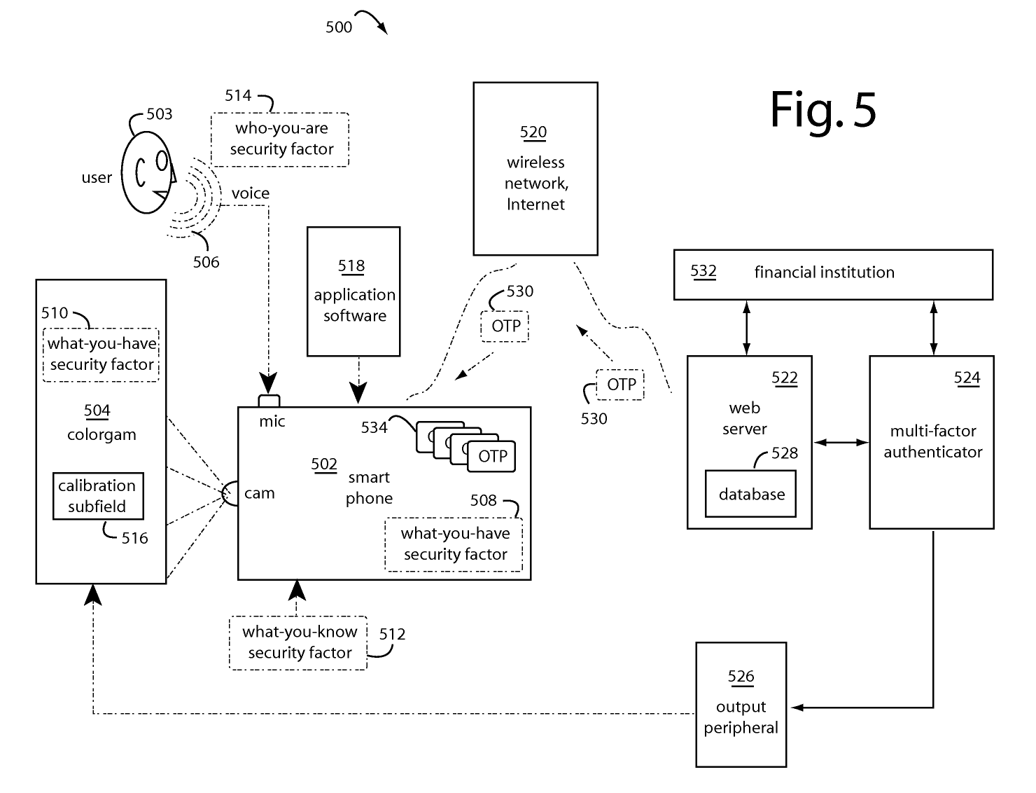

FIG. 5 represents a highly specialized application of an encoded colorgram system, herein referred to by the general reference numeral 500. Such example is intended to demonstrate a practical and important use of the colorgram technology claimed herein. A personal trusted device (PTD) such as a smartphone 502 is routinely carried by a user 503 along with a visual key or colorgram 504 in the form of a decal on a keychain or other personal item. A camera included in the smartphone 502 is able to image the colorgram 504 at will and a microphone can collect an audio sample of a user's voice 506.

Multi-factor authentication is provided by a what-you-have security factor 508 represented, e.g., by a SIM card in the smartphone 502, another what-you-have security factor 510 represented by the user's possession of colorgram 504, a what-you-know security factor 512 represented by a user's entry of a PIN, and a who-you-are security factor 514 represented by the user's voice 506. Some or all of these security factors can be collected in real-time and concatenated together to form a very long user authentication code.

The colorgram 504 may include various color marks and subfields 516 to assist in the image orienting, self-calibration, and interpretation of the color encoding carried by colorgram 504. Colorgram 504 includes visually encoded data in the form of colored cells from a standard palette of colors and arranged in a grid, radial pattern, matrix, or other pattern. The colored cells can be circles, squares, rectangles, ovals, or any other shape.

In one embodiment, a self-calibration subfield 516 includes a color cell from each of the standard palette of colors. If there are eight colors used in the standard palette, then there will be eight colored cells in the self-calibration subfield 516. These are arranged in a matrix in a standard way such that they can easily be recognized together as a self-calibration subfield 516 by an application software (app) 518 installed on the smartphone 502.

Environmental and product variations in the image capture of colorgram 504 with smartphone 502 can often produce large uncertainties in determining which colors in the standard palette of colors each colored cell in colorgram 504 represents. Application software 518 includes subroutines that register each of the color cells imaged in self-calibration subfield 516 as the possible choices, and each color cell from the colorgram 504 is compared to test which standard color is the closest match. The decisions can be reached quickly and with very few reading errors.

A determination of which color from the standard palette of colors is represented by each color cell in colorgram 504 can be ascertained by mapping all the colors visualized and finding the correlations amongst them.

User 503 and smartphone 502 may authenticate themselves through a wireless network 520 to a webserver 522. A multi-factor authenticator 524 can pre-issue credentials like colorgram 504 in the form of small stickers or decals printed on a printer or other output peripheral 526. When the concatenated user authentication code is returned through webserver 522, that portion representing the what-you-have security factor 510 can be verified by multi-factor authenticator 524. A database 528 maintains a list of accounts and one-time-passwords (OTP) 530 authorized by a financial institution 532, for example. A short-term supply of OTP's 534 is stored within smartphone 502 for use later when the network 520 is inaccessible.

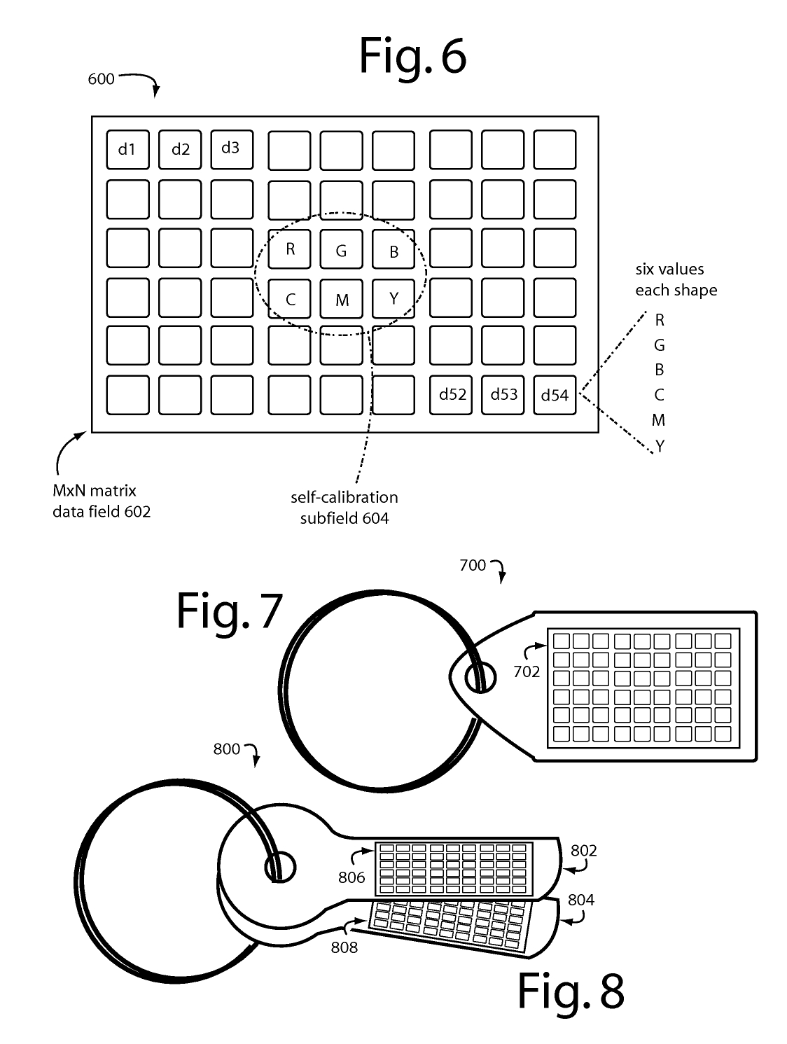

FIG. 6 represents a colorgram embodiment of the present invention, and is referred to herein by the general reference numeral 600. Colorgram 600 includes, in this example, a rectangular 9×6 matrix data field 602 decorated with a predetermined physical pattern of colored cells d1-d54. The variety of colors is limited to a finite set of colors in discrete steps. The whole is arranged and configured so that a digital camera in the PTD can image of all the colored cells d1-d54 at once. The choice of colors of each colored cell d1-d54 and its location within the predetermined physical pattern of matrix data field 602 is capable of encoding data.

The matrix can be any shape or size, dependent only on camera imaging capabilities. Colorgrams can be a rainbow shape of many color cells, or a “happy face” with various colors. Such shape-geometries have advantages over conventional 1D and 2D standardized geometry shapes.

A subfield 604 of colored cells is chosen to serve as a calibration subfield, and are disposed in an standardized place in the data field and a standardized choice of colors of each colored cell from the finite set of colors in discrete steps and a standardized location within the subfield. In this example, red-green-blue-cyan-magenta-yellow (R, G, B, C, M, and Y). All the other color cells d1-d54 which encode data must be one of these colors, and a processor using a camera to image matrix data field 602 can rely on this rule to speed recognition of the data encoded in colorgram 600.

The example of FIG. 6 uses six standard colors. If eight colors were the standard, each colored cell d1-d54 could be used to represent a 3-bit binary, 0-7 decimal. More colors and larger matrix sizes can be used to encode more data, but the limits are reached by the camera's abilities to resolve the cells and their colors within a larger matrix, or smaller matrix with smaller individual cells.

The calibration subfield 604 serves as a means to orient and synchronize the encoded data present in matrix data field 602. Such data is visually encoded into the data field as (1) a particular step in one of the color spots in the finite set, and (2) in respective locations within the matrix data field 602. Each place in the matrix data field 602 can carry a different weight, meaning, or act as a data definition. Reading the encoded data can begin with colored cell d1 and end with d54, for example. It is entirely possible, of course, to encode arbitrary data such as Internet Uniform Resource Locators (URLs), user information, file names, and other data.

FIG. 7 shows a practical application of a colorgram. A key fob 700 has a colorgram 702 that has been applied to it. The intention is that a user would routinely have such a key fob 300 on their person or handy within easy reach.

FIG. 8 represents a similar application of a colorgram. A key ring 800 has several “keys” 802 and 804 that respectively have different colorgrams 806 and 808 applied to them. A user would routinely have such a key ring 800 with conventional house and car keys on their person or handy within easy reach. Having separate, different colorgrams 806 and 808 would be advantageous when accessing different kinds of security devices, e.g., home and business.

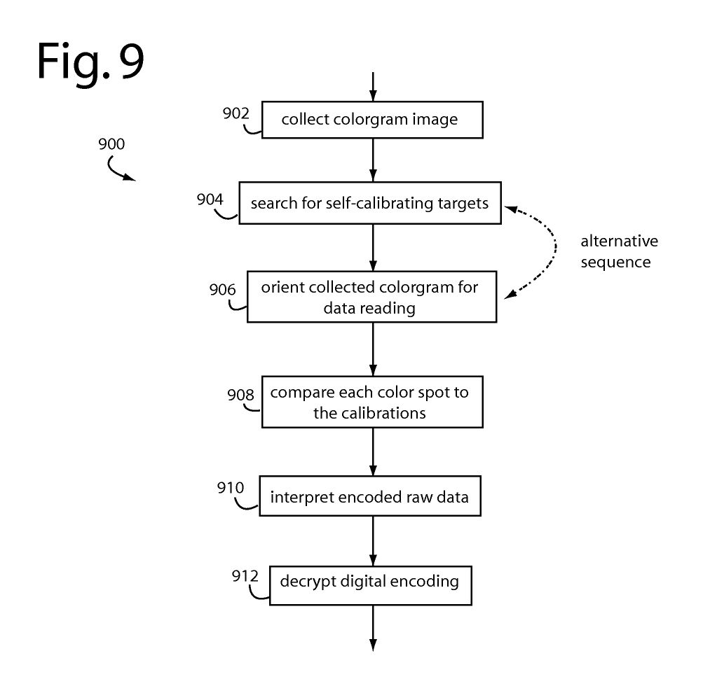

FIG. 9 represents a computer subroutine 900 that may be included, e.g., in downloaded application software 118 to read and interpret colorgrams and to extract the encoded data. A step 902 collects a colorgram image through an available camera. The image collected must be freshly captured by the camera data stream and not from a stored image, nor can it be retained after processing.

A step 904 searches the color cells in the colorgram image for a group of self-calibrating color subfields. In some instances, it may be preferable to complete rotational orientation step 906 first.

It may be useful to employ more than one kind of self-calibrating color subfield group. The particular group in use can be used to signal a general class or purpose of the colorgram in which it is embedded, e.g., banking versus social networking. Or the group can signal data field matrix sizes. The data also can signal this.

A step 906 uses the recognition of a rotational alignment cell as a means to orient the rest of the colored cells and data in the colorgram.

A step 908 compares each colored cell imaged by the camera for the colorgram against the discrete colors provided by the self-calibrating color subfield group. The self-calibrating color subfield group is the complete set of all the possible color steps that can exist in the colorgram, so every colored cell in the colorgram must match one of those steps. Any discrepancies in the captured images will be due to lighting, perspective, printing medias, display technologies, white-balance, imager, and other random and uncontrollable variations. Every image pixel can be represented numerically in terms of brightness, color saturation, and color hue. Step 908 matches each colored cell to the one cell in the self-calibrating color subfield group that has the smallest deviation.

A step 910 is then able to recover the raw data that was visually encoded as colors in the colorgram. If the raw data itself was encrypted, a step 912 decrypts this data, e.g., a URL for a website, a password, or as straight data.

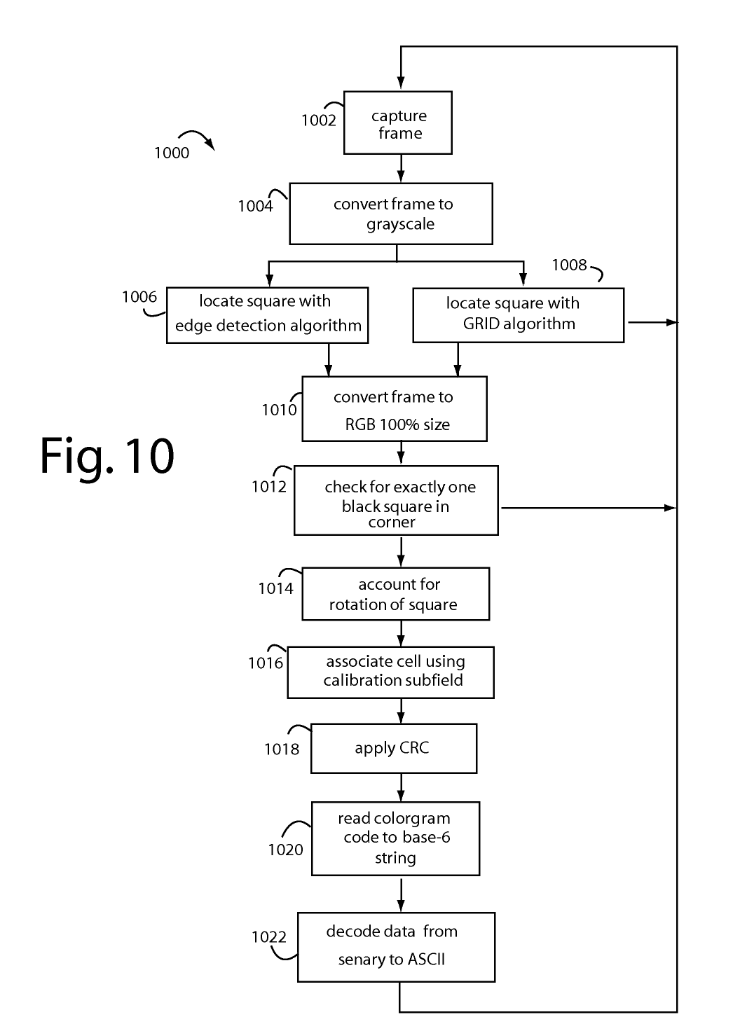

FIG. 10 represents an Automated Shutter Colorgram Capture (ASCC) colorgram recognition process embodiment of the present invention, and is referred to herein by the general reference numeral 1000. A step 1002 uses a camera to capture a video frame. A step 1004 converts the video frame to grayscale. A step 1006 uses an edge detection algorithm to find the location of the colorgram within the video frame. Alternatively, a step 1008 uses a color alignment. If neither finds the colorgram, step 1002 is used again to capture a better video frame.

A step 1010 converts the video frame into a full size color image. A step 1012 checks to see if a unique feature like a single black square in only one corner can be identified. Some embodiments may not employ this method.

A step 1014 accounts for any apparent rotation of the colorgram using a black corner square as an index. A step 1016 calibrates the colors in the colorgram using the calibration subfield cells as a reference. A step 1018 applies an cyclic redundancy check (CRC) to determine read accuracy. A step 1020 reads the colorgram as a senary (base-6) number string. A step 1022 decodes the base-6 senary string into an ASCII text string.

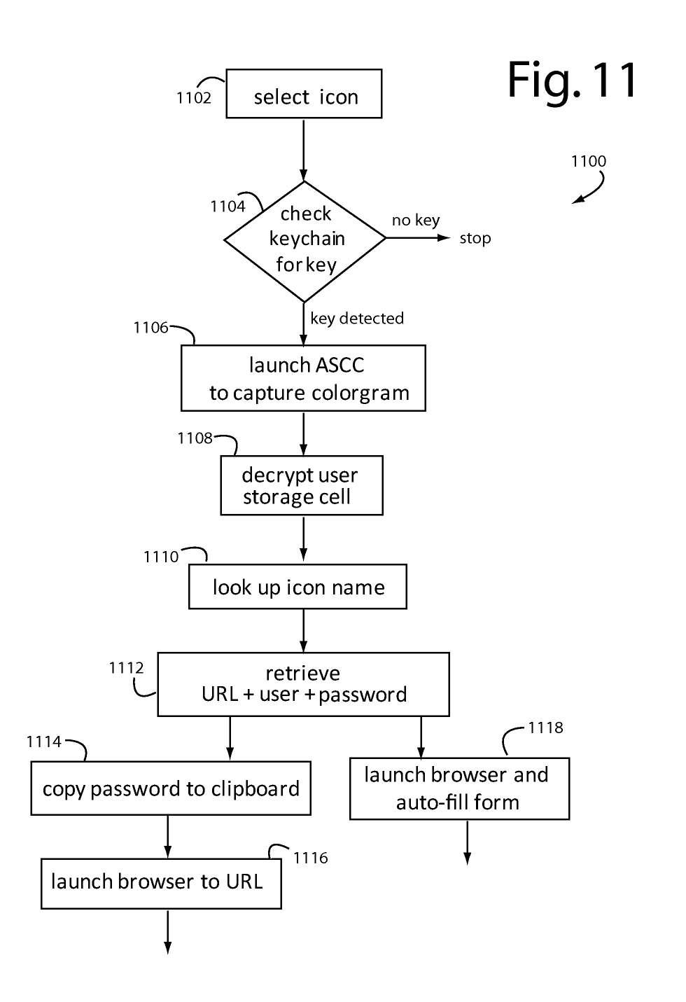

A program 1100 represented in FIG. 11 runs, for example, at top level in smartphone 502 (FIG. 5). Each secure application on the smartphone is represented on a display screen by a corresponding icon. In step 1102, the user selects the application icon that they want to launch. A decision 1104 decides if the keychain, like the one in FIG. 8, needs to be captured to collect its colorgram for one of the user authentication security factors. If so, a step 1106 launches an ASCC subroutine like that of FIG. 10. A step 1108 decrypts the user storage cell. A step 1110 looks up the relative icon data encoded in the colorgram. A step 1112 fetches the corresponding URL and adds in the user ID and the website password. Such password is a strong random password automatically generated on behalf of the user when enrolling the particular website to use the security gateway. A step 1114 copies the relevant PIN to the clipboard and a step 1116 launches the browser to the URL. Otherwise, a step 1118 launches the browser to the URL and an auto-fill log-in form.

In general, embodiments of the present invention provide devices and methods that make transactions traceable such that the transactions cannot be repudiated later. The tokens that are used in the authorizations and verification steps are personal and unique, quite impossible for fraudsters to duplicate, or substitute. So when a user employs such a token, the transaction is irretrievably attached to such as an identifier.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. An electronic transaction device, comprising:
a mobile personal trusted device (PTD) configured to communicate abstracts of objects over a network to a transaction server; and
a sensor included in the PTD for recording characteristic abstracts of objects carried by users and having distinctive features that can be associated with and registered to a particular user;
wherein, the PTD is configured to send to a server an abstract contemporaneously obtained during a secure transaction and used as an authenticator for comparison to an abstract previously obtained and registered to said user;
wherein, a traceable transaction record is obtained that is substantially indisputable.

2. The electronic transaction device of claim 1, further comprising:
a first computer executable file module for execution by said mobile electronics device and a remote server on a network to interactively register a cryptographic abstract of a sound or an image of an object available to a user, wherein data inputs representing said sounds and objects symbolize physical passwords from which audio and/or image processing can derive characterizing information for transactional authentication;
a second computer executable file module for execution by said mobile electronics device during a user transaction and that causes input data from a camera and/or microphone included in said mobile electronics device to collect a new sample and process the data into a present physical password for which a cryptographic abstract of it is distilled and compared to preregistered cryptographic abstracts, either locally or by accessing a remote server on the Internet; and
a third computer executable file module for a key recovery process, when a preregistered physical password sound or object is no longer available to the user, said user synchronizes the mobile electronics device on a vendor website and requests a key removal process, or that enables the user to contact a vendor to obtain a reset code, and wherein new physical passwords can then be registered with the first module.

3. The electronic transaction device of claim 1, further comprising:
a handset including at least a camera, a display screen, and a wireless communications device for accessing a network with a remote server;
a computer executable file module for execution by the handset, and including:
an imaging program providing for said camera to collect an image of an object with distinctive and characteristic features that are associative with a particular user;
an interactive graphical interface (GUI) providing for said display screen to assist said user in the collecting and qualification of said object as having enough distinctive and characteristic features to serve collectively as an authenticator for said user in a transaction;
an image processing program providing for the selection and reduction of features identified in an image of said object into abstracts;
an encoding program providing for the secure encryption of said abstracts;
wherein, an abstract previously obtained and registered to said user can be compared to an abstract contemporaneously obtained during a transaction and used as an authenticator to control attempts at fraud.

4. The electronic transaction device of claim 1, further comprising an encoded colorgram including:
a data field decorated with a predetermined physical pattern of colored cells, wherein the variety of colors is limited to a finite set of colors in discrete steps, and configured for imaging by a digital camera of all the colored cells at once, and wherein the choice of colors of each colored cell and its location within the predetermined physical pattern is interpreted as the encoding of data;
a subfield of calibrating colored cells disposed in an standardized place in the data field and a standardized choice of colors of each colored cell from the finite set of colors in discrete steps and a standardized location within the subfield; and
data that is visually encoded into the data field as a particular step in one of the color cells in the finite set and in their respective locations within the predetermined physical pattern;
wherein, the subfield of calibrating colored cells provides color decoding information on which discrete color step is represented by each of the colored cells in the data field.

5. The electronic transaction device of claim 4, further comprising:
a color print that includes the data field, the subfield, and the visually encoded data.

6. The electronic transaction device of claim 4, further comprising:
a physical token that can be readily carried by a consumer and which displays a color visual representation of the data field, the subfield, and the visually encoded data.

7. The electronic transaction device of claim 1, further comprising a first separate discrete object on which are displayed:
a data field decorated with a predetermined physical pattern of colored cells, wherein the variety of colors is limited to a finite set of colors in discrete steps, and configured for imaging by a digital camera of all the colored cells at once, and wherein the choice of colors of each colored cell and its location within the predetermined physical pattern is interpreted as the encoding of data;
a subfield of calibrating colored cells disposed in an standardized place in the data field and a standardized choice of colors of each colored cell from the finite set of colors in discrete steps and a standardized location within the subfield; and
data that is visually encoded into the data field as a particular step in one of the color cells in the finite set and in their respective locations within the predetermined physical pattern;
wherein, the subfield of calibrating colored cells provides color decoding information on which discrete color step is represented by each of the colored spots in the data field; and
a second separate discrete object including a device capable of visually imaging the first separate discrete object and then capable of interpreting the data by first using the subfield of calibrating colored cells to determine which of the finite set of colors in discrete steps is represented by each of the colored cells in the data field.

8. The electronic transaction device of claim 1, further comprising:
a security system with a software application configured to execute in a user's smartphone and a separately carried visual key that the user can image at will with the smartphone's camera, wherein said visual key comprises digital data encoded in a series of colored cells arranged in a colorgram, and such digital data is treated as a what-you-have security factor and is concatenated with other security factors so users can authenticate themselves to websites, Internet services, and smartphones and their applications.

9. The electronic transaction device of claim 5, further comprising:
a process for when a user authenticates themselves to a server, the server returns a short-term supply of one-time-passwords or account numbers for use in secure access and transactions on other systems.

10. A method for traceability and non-repudiation in electronic transactions, comprising:
configuring a mobile personal trusted device (PTD) to communicate over a network to a transaction server;
recording characteristic abstracts of objects carried by users and having distinctive features that can be associated with and registered to a particular user;
sending an abstract contemporaneously obtained during a secure transaction to a server for use as an authenticator for comparison to an abstract previously obtained and registered to said user; and
rendering a traceable transaction record that is substantially indisputable.

11. The method of claim 10, further comprising:
using a mobile electronics device to collect an image or audio recording of a physical token during a concomitant user transaction;
abstracting said image into at least forty bits of characterizing information;
authenticating said physical token, and in so doing said concomitant user transaction, by comparing an abstract of said physical token to one previously registered as legitimate; and
authorizing said concomitant user transaction depending on the results of the step of authenticating.

12. The method of claim 10, wherein:
the step of using said mobile electronics device to collect an image of a physical token is such that said physical token includes at least one of a colorgram, door key, car key, identification card, passport, drivers license, pendant, rings, bracelet, belt, handwritten signature or phrase, hand of said user, or other object not subject to unavailability or substantial changes in appearance over time.

13. The method of claim 10, wherein:
the step of using said mobile electronics device to collect an audio recording of a physical token is such that said physical token includes at least one of a word or phrase spoken by said user, a series or tones, or other sounds not subject to unavailability or substantial changes in character over time.

14. The method of claim 10, wherein:
providing a selection and registration process in which said user is allowed to select a particular physical token available to them.

15. The method of claim 10, wherein:
providing a selection and registration process in which a particular physical token available to said user is suggested through said mobile electronics device for registration.
